(19) United States
(12) Patent Application Publication
(10) Pub. No.: US 2020/0274133 A1
(43) Pub. Date: Aug. 27, 2020

(54) BATTERY AND METHOD FOR MANUFACTURING SAME

(71) Applicant: PANASONIC INTELLECTUAL PROPERTY MANAGEMENT CO., LTD., Osaka-shi, Osaka (JP)

(72) Inventors: Takumi Masumura, Osaka (JP); Toshio Yamashitafuji, Osaka (JP)

(73) Assignee: PANASONIC INTELLECTUAL PROPERTY MANAGEMENT CO., LTD., Osaka-shi, Osaka (JP)

(21) Appl. No.: 16/067,921

(22) PCT Filed: Dec. 15, 2016
(86) PCT No.: PCT/JP2016/005141

§ 371 Date: Jul. 3, 2018

(30) Foreign Application Priority Data
Feb. 19, 2016 (JP) 2016-030461

(51) Int. Cl. H01M 2/26; H01M 2/16; H01M 2/30; H01M 2/04; H01M 10/04

(52) U.S. Cl. CPC H01M 2/26; H01M 2/1673; H01M 10/049; H01M 2/0426; H01M 2/30

(57) ABSTRACT

A battery includes: a container that includes a first terminal electrically connected to a first electrode and a second terminal electrically connected to a second electrode, and accommodates the electrodes and an electrolyte: and a long first lead that is welded to the first terminal, and is used for electrically connecting the first terminal to an external apparatus. The first lead has a first welding mark in a welding portion to the first terminal. The first welding mark includes: a projecting curved first portion on a first side on which the first lead is electrically connected to the external apparatus; or a first portion that includes a linear portion extending in the width direction of the first lead, and curved portions curved from both ends of the linear portion toward a second side opposite to the first side.

### TECHNICAL FIELD

The present invention relates to a battery in which an external lead to be electrically connected to an external apparatus is welded to an electrode terminal, and a manufacturing method of the battery.

### BACKGROUND ART

An external lead made of a metal foil is attached to an electrode terminal (positive electrode terminal or negative electrode terminal) of a battery, and the battery is electrically connected to an external apparatus via an external lead. The attachment method of the external lead to the electrode terminal of the battery includes laser welding or resistance welding (Patent Literature 1). The laser welding is performed by overlaying a planned welding portion of the external lead on the electrode terminal and then by radiating a laser to the planned welding portion of the external lead from a laser welding machine. The resistance welding is performed by overlaying the planned welding portion of the external lead on the electrode terminal and then by pressing a welding bar of a resistance welding machine onto the planned welding portion of the external lead to achieve current carrying.

### CITATION LIST

### Patent Literature

PTL 1: Unexamined Japanese Patent Publication No. 2000-149912

### SUMMARY OF THE INVENTION

However, when an end of the external lead that is opposite to a welding portion to the electrode terminal is connected to an external apparatus, a load is charged on an edge of the welding portion on the external apparatus side, and the edge is apt to cause the external lead to peel from the electrode terminal.

The objective of the present disclosure is to provide a battery capable of suppressing the phenomenon in which the external lead to be electrically connected to an external apparatus peels from the electrode terminal, and a manufacturing method of the battery.

An aspect of the present disclosure relates to a battery including the following components:

an electrode group including a first electrode, a second electrode, and a separator interposed between the first electrode and the second electrode;

a container that includes a first terminal electrically connected to the first electrode and a second terminal electrically connected to the second electrode, and accommodates the electrode group and an electrolyte; and

a long first lead that is welded to the first terminal, and is used for electrically connecting the first terminal to the external apparatus.

The first lead has a first welding mark in a welding portion to the first terminal. The first welding mark includes: a projecting curved first portion projecting on a first side on which the first lead is electrically connected to the external apparatus; or a first portion that includes a linear portion extending in the width direction of the first lead, and curved portions curved from both ends of the linear portion toward a second side opposite to the first side.

Another aspect of the present disclosure relates to a battery manufacturing method including the following steps:

preparing a battery that includes the following components:
an electrode group including a first electrode, a second electrode, and a separator interposed between the first electrode and the second electrode; and
a container including a first terminal electrically connected to the first electrode and a second terminal electrically connected to the second electrode, and accommodating the electrode group and an electrolyte; and

preparing a long first lead used for electrically connecting the first terminal to the external apparatus.

The battery manufacturing method further includes the following steps:

overlaying a planned welding portion of the first lead on the first terminal of the container, and then, in order to preheat the planned welding portion, forming a first laser irradiation mark by radiating a laser to a position near the planned welding portion in the longitudinal direction of the first lead; and

welding the first lead to the first terminal and forming a first welding mark by radiating a laser to the planned welding portion in the state in which the planned welding portion is preheated.

Furthermore, each of the first laser irradiation mark and the first welding mark includes: a projecting curved first portion projecting on a first side on which the first lead is electrically connected to the external apparatus; or a first portion that includes a linear portion extending in the width direction of the first lead, and curved portions curved from both ends of the linear portion toward a second side opposite to the first side.

The present disclosure suppresses the phenomenon in which the external lead for electrically connecting the battery to an external apparatus peels from the electrode terminal.

### BRIEF DESCRIPTION OF DRAWINGS

FIG. 1 is a schematic diagram showing a specific example of a first welding mark included in a first lead of a battery in accordance with the present invention.

FIG. 2 is a schematic diagram showing a welding mark included in a first lead of a battery of a comparative example.

FIG. 3 is a schematic side view of a cylindrical battery in accordance with an exemplary embodiment of the present invention.

FIG. 4 is a schematic vertical sectional view of battery body 10 shown in FIG. 3.

FIG. 5 is a bottom view of an essential part of the cylindrical battery shown in FIG. 3.

FIG. 6 is an enlarged view of an essential part of negative electrode external lead 21 shown in FIG. 5.

FIG. 7 is a top view of an essential part of the cylindrical battery shown in FIG. 3.

### DESCRIPTION OF EMBODIMENT(S)

An exemplary embodiment of the present invention relates to a battery including a battery body and an external lead attached to the battery body. The battery body includes the following components:

an electrode group including a first electrode, a second electrode, and a separator interposed between the first electrode and the second electrode; and

a container that includes a first terminal electrically connected to the first electrode and a second terminal electrically connected to the second electrode, and accommodates the electrode group and an electrolyte.

The external lead is used for electrically connecting the battery body to the external apparatus. In other words, in the battery, a long first lead for electrically connecting the first terminal to the external apparatus is welded to the first terminal of the battery body. The first lead has a first welding mark (=remaining trace) in a welding portion to the first terminal. One of the first electrode and the second electrode is a positive electrode, and the other is a negative electrode. The electrode group may be a stacking type or a winding type. As the first lead, a metal foil is employed, for example.

When the first welding mark is a dot-like welding mark, a load is concentrated on one point. Therefore, the point is apt to become a starting point of peeling of the first lead from the first terminal, and hence a problem occurs in which a sufficient welding strength cannot be obtained. When the first welding mark is a welding mark having a projecting polygonal line portion on a side on which the first lead is electrically connected to the external apparatus, a load is concentrated on a tip of the polygonal line portion. Therefore, the tip is apt to become a starting point of peeling of the first lead from the first terminal, and hence a problem occurs in which a sufficient welding strength cannot be obtained. When the first welding mark is a linear welding mark extending along a width direction of the first lead, a load is concentrated on both ends of the linear welding mark. Therefore, at least one of both ends is apt to become a starting point of peeling of the first lead from the first terminal, and hence a problem occurs in which a sufficient welding strength cannot be obtained.

In the exemplary embodiment of the present invention, forming the first welding mark in a specific shape eliminates the above-mentioned problems to increase the welding strength. The number of first welding marks may be one or more. When the first lead includes a plurality of first welding marks, the first welding marks may have the same shape or different shapes.

In a first specific form of the present invention, a first welding mark includes a projecting curved first portion on a first side on which the first lead is electrically connected to an external apparatus (hereinafter simply referred to as “first side”).

The first welding mark includes a projecting curved first portion projecting on the first side. Therefore, even when the end of the first lead on the first side is connected to the external apparatus, a load is not concentrated on one point and the load can be dispersed.

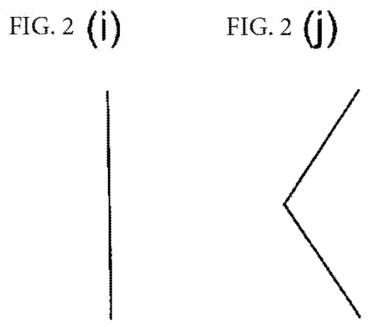

As shown in FIG. 2(i), in the case that the welding mark in the first lead is formed of only a linear portion extending in the width direction of the first lead, when the end of the first lead on the first side is connected to an external apparatus, a load is charged on both ends of the linear portion. Therefore, at least one of both ends is apt to become a starting point of peeling of the first lead from the first terminal.

Conversely, in the exemplary embodiment of the present invention, the first welding mark includes a projecting curved first portion projecting on the first side. Both ends of the first portion are located on the second side opposite to the first side with respect to a central part of the first portion. Therefore, the load charged on both ends of the first portion is reduced, and at least one of both ends is prevented from becoming a starting point of peeling of the first lead from the first terminal.

When the first portion has a curved shape, the first portion can be made longer in the width direction of the first lead than when the first portion has a linear shape. The load charged on the first portion from the first side can be more sufficiently dispersed, and the connection strength of the welding portion is also increased. Forming the first portion in the curved shape is useful especially when the width of the first lead is small (for example, the width of the first lead is 3 mm or less or 2 mm or less).

As shown in FIG. 2(j), in the case that the welding mark of the first lead includes a projecting polygonal line portion on the first side (left side in FIG. 2), when the end of the first lead on the first side is connected to an external apparatus, a load is concentrated on the tip of the polygonal line portion. Therefore, the tip is apt to become a starting point of peeling of the first lead from the first terminal.

Conversely, in the exemplary embodiment of the present invention, the first welding mark includes a projecting curved first portion on the first side. Therefore, the above-mentioned phenomenon does not occur in which the load is concentrated on the tip of the polygonal line portion and the tip becomes a starting point of peeling of the first lead from the first terminal.

In the first welding mark of the first specific form, it is preferable that curvature radius R of the curved first portion is 0.5 or more. When curvature radius R is 0.5 or more, the load charged on the first portion is easily and sufficiently dispersed.

The curved shape may be a circular arc shape having a constant curvature or a circular arc shape having a gradually varying curvature. In addition, the curved shape may include a corrugated shape.

In a second specific form of the present invention, a first welding mark includes a first portion having; a linear portion extending in the width direction of the first lead; and curved portions curved from both ends of the linear portion toward a second side opposite to the first side. The end of each curved portion that is opposite to the end of the linear portion side is located closer to the outside in the width direction of the first lead than the end of the curved portion on the linear portion side is. The angle between the linear portion and the longitudinal direction of the first lead is for example 70° to 110° inclusive, preferably 90°.

The first welding mark includes a linear portion extending in the width direction of the first lead. Therefore, even when the end of the first lead on the first side is connected to an external apparatus, a load is not concentrated on one point and the load can be dispersed.

The existence of the curved portion reduces the load charged on both ends of the first portion. Therefore, the phenomenon does not occur in which, as in the case of the welding mark having the shape shown in FIG. 2(i), at least one of both ends is apt to become a starting point of peeling of the first lead from the first terminal.

The existence of the linear first portion extending in the width direction of the first lead prevents the phenomenon in which, as in the case of the welding mark having the shape shown in FIG. 2(j), the load is concentrated on the tip of the polygonal line portion and the tip is apt to become a starting point of peeling of the first lead from the first terminal.

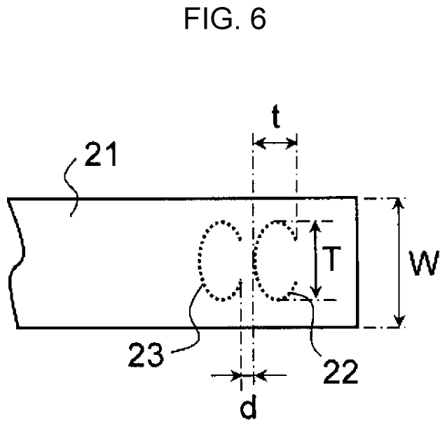

In the first welding mark of the second specific form, it is preferable that width W of the first lead and length L of the linear portion satisfy the relational expression: 0.3≤L/W≤0.6 (see FIG. 6). When L/W is 0.3 or more, a load charged on the linear portion can be sufficiently dispersed. When L/W is 0.6 or less, the region to have the curved portion can be sufficiently kept, and the load charged on both ends of the first welding mark can be sufficiently reduced. Here, the region having the curve is included in the curved portion.

Preferably, the first welding mark further includes: second portions curved from both ends of the first portion toward the center in the width direction of the first lead; or second portions extending linearly from both ends of the first portion in the longitudinal direction of the first lead toward the second side opposite to the first side. Both ends of the first portion mean the outermost parts of the first portion in the width direction of the first lead. The line interconnecting both ends of the first portion has for example an angle of 70° to 110° inclusive, preferably an angle of 90°, with respect to the longitudinal direction of the first lead. Each second portion extending linearly in the longitudinal direction of the first lead may have an angle of 20° or less with respect to the longitudinal direction of the first lead.

The existence of the second portions can further reduce the load charged on both ends of the first welding mark, and can more certainly prevent at least one of both ends from becoming a starting point of peeling of the first lead from the first terminal. The length of the first welding mark can be increased, and the connection strength of the welding portion is also increased.

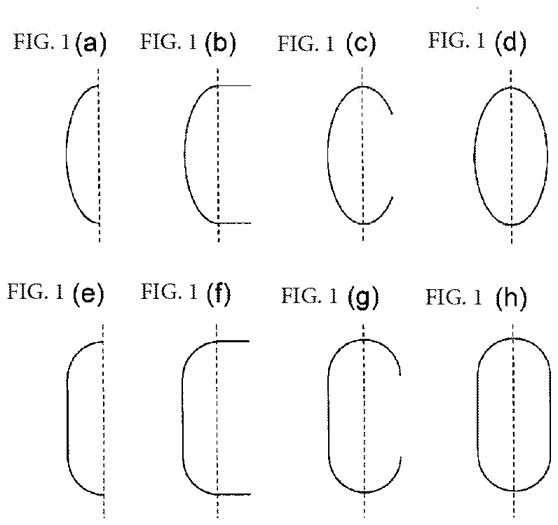

As the first welding mark of the above-mentioned first specific form, first welding marks having the shapes shown in FIG. 1(a) to FIG. 1(d) are provided, for example. In the first welding marks shown in FIG. 1(a) to FIG. 1(d), the left part with respect to the broken line in each of FIG. 1(a) to FIG. 1(d) is the first portion, and the right part with respect to the broken line in each of FIG. 1(a) to FIG. 1(d) is the second portion. In each of FIG. 1(a) to FIG. 1(d), the left side is the first side.

FIG. 1(a) shows a first welding mark formed of only a projecting curved first portion on the first side. FIG. 1(b) shows a first welding mark including second portions that extend from both ends of the first portion shown in FIG. 1(a) linearly in the longitudinal direction of the first lead toward the second side opposite to the first side. Each of FIG. 1(c) and FIG. 1(d) shows a first welding mark including second portions that are curved from both ends of the first portion shown in FIG. 1(a) toward the center in the width direction of the first lead. FIG. 1(d) shows a first welding mark when the welding final end is disposed near the welding start end.

As the first welding mark of the above-mentioned second specific form, first welding marks having the shapes shown in FIG. 1(e) to FIG. 1(h) are provided, for example. In the first welding marks shown in FIG. 1(e) to FIG. 1(h), the left part with respect to the broken line in each of FIG. 1(e) to FIG. 1(h) is the first portion, and the right part with respect to the broken line in each of FIG. 1(e) to FIG. 1(h) is the second portion. In each of FIG. 1(e) to FIG. 1(h), the left side is the first side.

FIG. 1(e) shows a first welding mark formed of only a first portion that includes: a linear portion extending in the width direction of the first lead; and curved portions curved from both ends of the linear portion toward the second side opposite to the first side. FIG. 1(f) shows a first welding mark including second portions that extend from both ends of the first portion shown in FIG. 1(e) linearly in the longitudinal direction of the first lead toward the second side opposite to the first side. Each of FIG. 1(g) and FIG. 1(h) shows a first welding mark including second portions that are curved from both ends of the first portion shown in FIG. 1(e) toward the center in the width direction of the first lead. FIG. 1(h) shows a first welding mark when the welding final end is disposed near the welding start end.

Preferably, in the width direction of the first lead, at least one of the welding start end and the welding final end of the first welding mark is located inside the outermost part of the first welding mark in the width direction of the first lead. The load charged on the ends (welding start end and welding final end) of the first welding mark is greatly reduced, and the effect of preventing the ends from becoming starting points of peeling of the first lead from the first terminal can be remarkably produced.

Examples of such first welding mark include first welding marks shown in FIG. 1(c), FIG. 1(d), FIG. 1(g), and FIG. 1(h). From the viewpoint of controlling the penetration depth into the first terminal near the welding start end and welding final end (reducing the variation in penetration depth of the first welding mark into the first terminal), it is preferable to employ the first welding marks shown in FIG. 1(c) and FIG. 1(g) in which the welding start end is sufficiently separate from the welding final end. Furthermore, from the viewpoint of dispersing the load in the width direction of the first lead, it is more preferable to employ the first welding mark shown in FIG. 1(c) that has a projecting curved first portion on the first side.

Length T of the first welding mark in the width direction of the first lead and length t of the first welding mark in the longitudinal direction of the first lead preferably satisfy relational expression (1): T/t>1, more preferably satisfy relational expression: T/t≥1.5. When relational expression (1) is satisfied, a well-balanced and stable welding strength can be kept in the width direction and longitudinal direction of the first lead.

In the case that one side in the width direction of the first lead is set as a third side and the other side in the width direction of the first lead is set as a fourth side, length T of the first welding mark in the width direction of the first lead indicates the maximum value of the distance between the following points:

the point of the first welding mark that is located closest to the third side; and

the point of the first welding mark that is located closest to the fourth side.

Length t of the first welding mark in the longitudinal direction of the first lead indicates the maximum value of the distance between the following points:

the point of the first welding mark that is located closest to the first side; and

the point of the first welding mark that is located closest to the second side.

Since the first welding mark is formed in the first lead, it is preferable that length T of the first welding mark in the width direction of the first lead and width

W of the first lead satisfy the relational expression: T/W<1. In order to keep a stable welding strength in the width direction of the first lead, it is more preferable that T/W is 0.1 or more and less than 1. In order to keep a stable welding strength in the width direction of the first lead, it is preferable that T is 1 mm or more. From the viewpoint of the container size (for example, the outer diameter of the cylindrical container is 2.5 to 10 mm inclusive), W is preferably 10 mm or less, more preferably 2.5 to 10 mm inclusive.

A first welding mark having the above-mentioned specific shape is formed by overlaying a planned welding portion of a first lead on a first terminal of the battery body, and then by radiating a laser to the planned welding portion to weld the first lead to the first terminal. As the laser welding, for example, a line welding with a fiber laser, or a pulse welding with an yttrium aluminum garnet (YAG) laser or the like is employed. From the viewpoint of dispersing the load charged on the first welding mark, the line welding with a fiber laser is preferable.

Preferably, the first lead includes a first laser irradiation mark at a position that is parallel with and close to the first welding mark in the longitudinal direction of the first lead. The first laser irradiation mark may be located on the first side of the first welding mark, or may be located on the second side of the first welding mark. In order to preheat the planned welding portion of the first lead to the first terminal, the first laser irradiation mark is formed by radiating a laser to the first lead.

The first laser irradiation mark may serve as a welding mark, but it is preferable that the first laser irradiation mark does not serve as the welding mark (it is not welded to the first terminal). When the first laser irradiation mark does not serve as the welding mark, the phenomenon does not occur in which the welding of the first lead to the first terminal affects the heat dissipation of the first lead, and the planned welding portion can be stably preheated.

The objective of this preheating is to reduce the variation in welding temperature in the planned welding portion and to reduce the variation in the penetration depth of the first welding mark into the first terminal. Thus, the penetration depth can be stably controlled. Therefore, even when the first terminal is thin, for example 0.15 mm or less, a first welding mark having a predetermined penetration depth is stably obtained without causing the phenomenon in which penetration in the first terminal causes a leak of the electrolyte. From the viewpoint of the strength of the first terminal and the penetration depth of the first welding mark, the first terminal needs to have a thickness of at least 0.05 mm.

Preferably, distance d between the first welding mark and first laser irradiation mark is more than 0 mm and 0.5 mm or less. Distance d indicates the distance between the end of the first welding mark on the first laser irradiation mark side and the end of the first laser irradiation mark on the first welding mark side in the longitudinal direction of the first lead.

When distance d is 0.5 mm or less, the planned welding portion in which the first welding mark is to be formed can be sufficiently preheated, and a first welding mark having a small variation in penetration depth into the first terminal can be formed. When distance d is more than 0 mm, a first welding mark having a small variation in penetration depth into the first terminal can be stably formed without being affected by the first laser irradiation mark.

A manufacturing method of a battery in which a first lead having a first laser irradiation mark and first welding mark is attached to the first terminal is provided. The manufacturing method includes the following processes:

(1) preparing a battery body;

(2) preparing a long first lead used for electrically connecting the first terminal of the battery body to an external apparatus;

(3) overlaying a planned welding portion of the first lead on the first terminal of the battery body, and then, in order to preheat the planned welding portion, forming a first laser irradiation mark by radiating a laser to a position near the planned welding portion in the longitudinal direction of the first lead; and

(4) welding the first lead to the first terminal and forming a first welding mark, by radiating a laser to the planned welding portion in the state in which the planned welding portion is preheated.

Then, in the fourth process, the first welding mark is formed in the above-mentioned specific shape.

As the laser welding in the third process and fourth process, for example, a line welding with a fiber laser, or a pulse welding with a YAG laser or the like is employed. From the viewpoint of dispersing the load charged on the first welding mark, the line welding with a fiber laser is preferable.

The third process of previously applying a predetermined heat to the planned welding portion has the following objectives:

the welding temperature in the planned welding portion during the welding in the fourth process is equalized; and hence

the variation in the penetration depth, into the first terminal, of the first welding mark formed in the fourth process is reduced.

Regarding the laser irradiation in the third process, the irradiation condition such as irradiation intensity needs to be appropriately determined so that the planned welding portion is sufficiently preheated. In the third process, it is desirable that the first lead is not welded to the first terminal. The phenomenon does not occur in which the welding of the first lead to the first terminal affects the heat dissipation of the first lead, and the planned welding portion can be stably preheated.

The first laser irradiation mark needs to be formed so that, in the first welding mark forming process of the fourth process, a predetermined heat can be previously and sufficiently applied to the planned welding portion to equalize the welding temperature in the planned welding portion. The shape of the first laser irradiation mark is not particularly limited. The shape of the first laser irradiation mark may be the same as that of the first welding mark, or may be different from that of the first welding mark.

Regarding the laser irradiation in the fourth process, the irradiation condition such as irradiation intensity needs to be appropriately determined so that the penetration depth of the first welding mark into the first terminal is within a predetermined range.

The battery body is not particularly limited as long as, in order to electrically connect the battery body to an external apparatus via an external lead, the external lead needs to be welded to the electrode terminal of the battery body. In a small battery body in which the electrode terminal (surface area of the welding portion) is small and thin, a remarkable effect can be produced by disposing the above-mentioned first welding mark and first laser irradiation mark. For example, this battery body is a small-diameter cylindrical battery having a cylindrical container, and the outer diameter of the container is 3 mm or more and 10 mm or less.

A battery of another exemplary embodiment of the present invention further includes a long second lead that is welded to the second terminal and is used for electrically connecting the second terminal to an external apparatus. Preferably, the second lead has a second welding mark similar to the first welding mark. Also regarding the second lead, an effect similar to that when the first lead has the first welding mark is produced. The second lead is made of a metal foil, for example.

Preferably, the second lead has a second laser irradiation mark similar to the first laser irradiation mark. Also regarding the second lead, an effect similar to that when the first lead has the first laser irradiation mark is produced.

Hereinafter, as the battery of the exemplary embodiment of the present invention, an example of a small-diameter cylindrical battery in which the outer diameter of the container is 2.5 mm or more and 10 mm or less is shown.

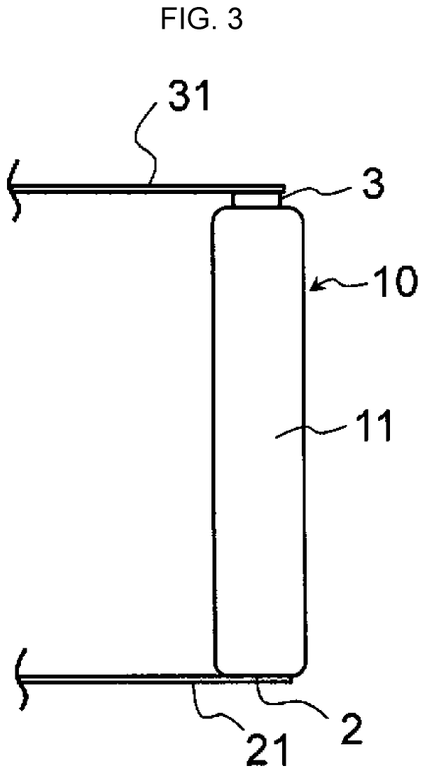

As shown in FIG. 3, the battery includes: cylindrical battery 10 as the battery body; negative-electrode external lead 21 welded to negative electrode terminal 2 of cylindrical battery 10; and positive-electrode external lead 31 welded to positive electrode terminal 3 of cylindrical battery 10. The end of negative-electrode external lead 21 that is opposite to the end thereof welded to negative electrode terminal 2 is a portion to be electrically connected to an external apparatus. The end of positive-electrode external lead 31 that is opposite to the end thereof welded to positive electrode terminal 3 is a portion to be electrically connected to the external apparatus.

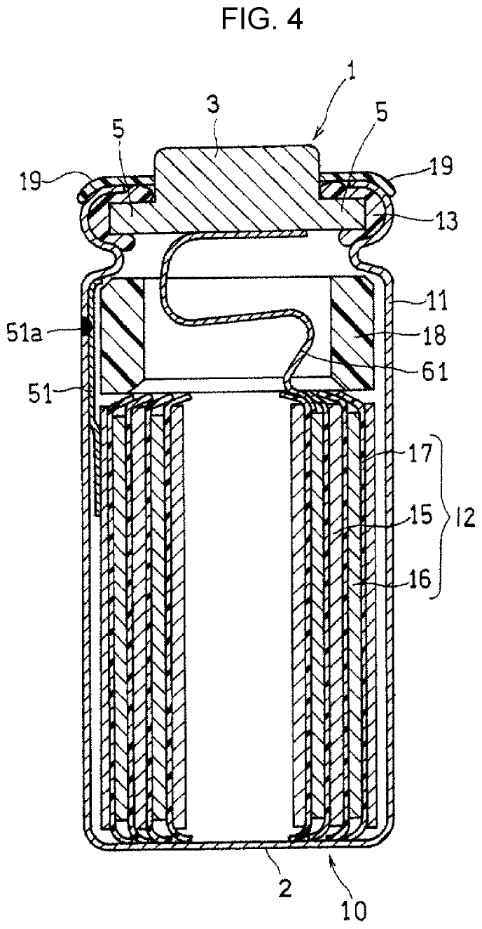

As shown in FIG. 4, cylindrical battery 10 includes: bottomed cylindrical battery case 11 having an opening; winding-type electrode group 12 and an electrolyte (not shown) accommodated in battery case 11; and sealing body 1 for sealing the opening in battery case 11. Electrode group 12 includes negative electrode 15, positive electrode 16, and separator 17 interposed between negative electrode 15 and positive electrode 16. Electrode group 12 is impregnated with the electrolyte.

At the rim of sealing body 1, ring-shaped insulating gasket 13 is disposed so as to cover collar portion 5. Then, the opening end of battery case 11 is bent inward via gasket 13, and is caulked to the rim of sealing body 1, thereby sealing battery case 11.

A space is formed between sealing body 1 and the upper end surface (top surface) of electrode group 12. Insulating ring 18 is disposed in this space, and regulates the contact between electrode group 12 and sealing body 1.

One end of ribbon-shaped positive-electrode internal lead 61 is connected to positive electrode 16 (exposed portion of positive-electrode current collector) by welding or the like on the inner peripheral side of winding-type electrode group 12. The other end is passed through a hole formed in the center of insulating ring 18, and then is connected to the lead welding surface of sealing member 1 by welding. In other words, positive electrode 16 is electrically connected to sealing member 1 via positive-electrode internal lead 61, and sealing member 1 serves as an external positive-electrode terminal. In other words, the central part of sealing member 1 includes projecting positive electrode terminal 3 to which positive-electrode external lead 31 to be electrically connected to an external apparatus is to be welded.

Regarding negative electrode 15, a negative-electrode active material layer is produced only on one surface of the outermost periphery of winding-type electrode group 12, and a negative-electrode current collector is exposed on the other surface. The exposed negative-electrode current collector faces the inner wall of battery case 11. The negative-electrode current collector on the outermost periphery is connected to one end of negative-electrode internal lead 51 by welding or the like, and the other end of negative-electrode internal lead 51 is connected to the inner wall of battery case 11 at welding point 51a. In other words, negative electrode 15 is electrically connected to battery case 11 via negative-electrode internal lead 51, and battery case 11 serves as an external negative-electrode terminal. In other words, the bottom part of battery case 11 includes negative electrode terminal 2 to which negative-electrode external lead 21 to be electrically connected to an external apparatus is to be welded.

Doughnut-shaped insulating layer 19 made of an electric insulating material is disposed so as to cover the outer surface of the bent opening end of battery case 11 and the surface of the gasket around the outer surface. When viewed from the outside of the battery, near the opening in battery case 11, insulating layer 19 more certainly separates sealing member 1 and battery case 11 that have opposite polarities from each other, and can effectively suppress an external short circuit.

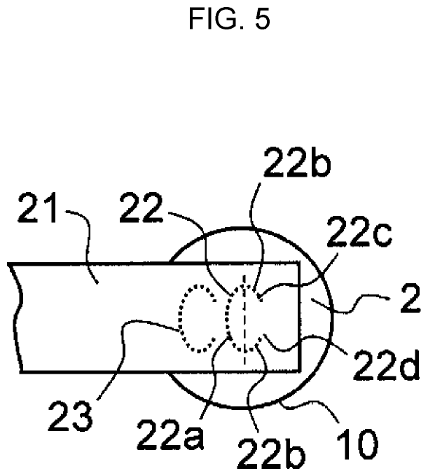

As shown in FIG. 5, negative-electrode external lead 21 includes a projecting substantially-C-shaped first welding mark 22 on the first side (left side in FIG. 5) on which negative-electrode external lead 21 is electrically connected to an external apparatus. First welding mark 22 includes a projecting curved first portion 22a on the first side (left part with respect to the broken line of first welding mark 22), so that the load charged on first welding mark 22 is dispersed.

First welding mark 22 includes second portion 22b curved from both ends of first portion 22a toward the center in the width direction of negative-electrode external lead 21 (right part with respect to the broken line of first welding mark 22). In the width direction of negative-electrode external lead 21, welding start end 22c and welding final end 22d of first welding mark 22 are located inside the outermost part of first welding mark 22 in the width direction of negative-electrode external lead 21. Therefore, the load charged on the ends (welding start end 22c and welding final end 22d) of first welding mark 22 is greatly reduced, and the effect of preventing the ends from becoming starting points of peeling of negative-electrode external lead 21 from negative electrode terminal 2 can be remarkably produced.

In FIG. 6, preferably, length T of first welding mark 22 in the width direction of negative-electrode external lead 21 and length t of first welding mark 22 in the longitudinal direction of negative-electrode external lead 21 satisfy relational expression (1): T/t>1. When relational expression (1) is satisfied, a well-balanced and stable welding strength can be kept in the width direction and longitudinal direction of negative-electrode external lead 21. When the end of negative-electrode external lead 21 has been connected to an external apparatus, a load is charged on first welding mark 22 from the first side (left side in FIG. 6) of negative-electrode external lead 21. Therefore, as the value of T becomes larger, the load can be more sufficiently dispersed.

Preferably, length T of first welding mark 22 in the width direction of negative-electrode external lead 21 and width W of negative-electrode external lead 21 satisfy relational expression (2): 0.5≤T/W<1. When relational expression (2) is satisfied, a stable welding strength can be kept in the width direction of negative-electrode external lead 21.

Width W of negative-electrode external lead 21 is 1 to 10 mm inclusive, for example. Width W of negative-electrode external lead 21 is determined appropriately in accordance with the outer diameter of battery case 11.

As shown in FIG. 5, negative-electrode external lead 21 includes first laser irradiation mark 23 at a position that is parallel with and close to first welding mark 22 in the longitudinal direction of negative-electrode external lead 21. First laser irradiation mark 23 and first welding mark 22 are disposed sequentially from the first side.

First laser irradiation mark 23 is formed by radiating a laser to negative-electrode external lead 21, in order to preheat the planned welding portion of negative-electrode external lead 21 to negative electrode terminal 2. First laser irradiation mark 23 may serve as a welding mark. The objective of this preheating is to reduce the variation in welding temperature in the planned welding portion and to reduce the variation in the penetration depth of first welding mark 22 into negative electrode terminal 2. Thus, the penetration depth can be stably controlled. Therefore, even when negative electrode terminal 2 (bottom of battery case 11) is thin, for example 0.15 mm or less, first welding mark 22 of a predetermined penetration depth is stably obtained without penetrating negative electrode terminal 2. As a result, the problem can be prevented in which negative electrode terminal 2 (bottom of battery case 11) gets a hole during laser irradiation for forming first welding mark 22 and the electrolyte leaks to the outside of battery 10 through the hole.

From the viewpoint of the strength of battery case 11 and the penetration depth of the first welding mark, battery case 11 (negative electrode terminal 2) needs to have a thickness of at least 0.08 mm.

Preferably, distance d between first welding mark 22 and first laser irradiation mark 23 is 0 mm or more and 0.5 mm or less. When distance d is 0.5 mm or less, the planned welding portion in which first welding mark 22 is to be formed can be sufficiently preheated, and first welding mark 22 having a small variation in penetration depth into negative electrode terminal 2 can be formed. When distance d is 0 mm or more, first welding mark 22 having a small variation in penetration depth into negative electrode terminal 2 can be stably formed without being affected by first laser irradiation mark 23.

For example, even when negative-electrode external lead 21 of a width of 2 mm or less is welded to thin negative electrode terminal 2 of a thickness of 0.15 mm or less, forming first laser irradiation mark 23 and first welding mark 22 can achieve a high welding strength and greatly improve the reliability of welding.

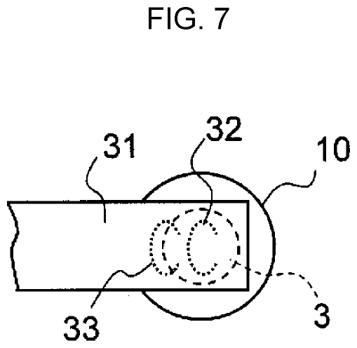

As shown in FIG. 7, positive-electrode external lead 31 includes substantially-C-shaped second welding mark 32 having the same shape as that of first welding mark 22. As shown in FIG. 7, positive-electrode external lead 31 includes second laser irradiation mark 33 at a position that is parallel with and close to second welding mark 32 in the longitudinal direction of positive-electrode external lead 31. From the first side, second laser irradiation mark 33 and second welding mark 32 are disposed in this sequence. Disposing second welding mark 32 and second laser irradiation mark 33 in positive-electrode external lead 31 produces the same effect as that when first welding mark 22 and first laser irradiation mark 23 are disposed in negative-electrode external lead 21.

### INDUSTRIAL APPLICABILITY

The present invention is applied to a battery in which an external lead to be electrically connected to an external apparatus is welded to an electrode terminal, especially to a small-diameter cylindrical battery.

### REFERENCE MARKS IN THE DRAWINGS

1 sealing body

2 negative electrode terminal

3 positive electrode terminal

5 collar portion

10 cylindrical battery

11 battery case

12 winding-type electrode group

13 insulating gasket

15 negative electrode

16 positive electrode

17 separator

18 insulating ring

19 insulating layer

21 negative-electrode external lead

22 first welding mark

22a first portion

22b second portion

22c welding start end

22d welding final end

23 first laser irradiation mark

31 positive-electrode external lead

32 second welding mark

33 second laser irradiation mark

51 negative-electrode internal lead

51a welding point

61 positive-electrode internal lead

1. A battery comprising:
an electrode group including a first electrode, a second electrode, and a separator interposed between the first electrode and the second electrode;
a container including a first terminal electrically coupled to the first electrode and a second terminal electrically coupled to the second electrode, and configured to accommodate the electrode group and an electrolyte; and
a long first lead welded to the first terminal, and used for electrically coupling the first terminal to an external apparatus,
wherein the first lead has a first welding mark in a welding portion to the first terminal, and
wherein the first welding mark includes:
a projecting curved first portion projecting on a first side on Which the first lead is electrically coupled to the external apparatus; or
a first portion including:
a linear portion extending in a width direction of the first lead; and
curved portions curved from both ends of the linear portion toward a second side opposite to the first side.

2. The battery according to claim 1, wherein
the first welding mark further includes:
second portions curved from both ends of the first portion toward a center in the width direction of the first lead; or
second portions linearly extending from the both ends of the first portion in a longitudinal direction of the first lead toward the second side opposite to the first side.

3. The battery according to claim 1, wherein
in the width direction of the first lead, at least one of a welding start end and a welding final end of the first welding mark is located inside an outermost part of the first welding mark in the width direction of the first lead.

4. The battery according to claim 1, wherein
a length T of the first welding mark in the width direction of the first lead and a length t of the first welding mark in a longitudinal direction of the first lead satisfy a relational expression: T/t>1.

5. The battery according to claim 1, wherein
a length T mm of the first welding mark in the width direction of the first lead and a width W mm of the first lead satisfy a relational expression: 0.1≤T/W<1, 1≤T, and W≤10.

6. The battery according to claim 1, wherein
the first lead includes a first laser irradiation mark at a position near the first welding mark in a longitudinal direction of the first lead.

7. The battery according to claim 6, wherein
the first welding mark and the first laser irradiation mark are separated from each other by 0.5 min or less.

8. The battery according to claim 1, wherein
a thickness of the first terminal of the container is 0.05 mm or more and 0.15 mm or less.

9. The battery according to claim 1, wherein
the container has a cylindrical shape, and
an outer diameter of the container is 2.5 mm or more and 10 min or less.

10. The battery according to claim 1, further comprising a long second lead welded to the second terminal and used for electrically coupling the second terminal to the external apparatus,
wherein the second lead has a second welding mark in a welding portion to the second terminal, and
wherein the second welding mark includes:
a projecting curved first portion projecting on a first side on which the second lead is electrically coupled to the external apparatus; or
a first portion including:
a linear portion extending in a width direction of the second lead; and
curved portions curved from both ends of the linear portion toward a second side opposite to the first side.

11. A battery manufacturing method comprising:
preparing a battery including:
an electrode group including a first electrode, a second electrode, and a separator interposed between the first electrode and the second electrode; and
a container including a first terminal electrically coupled to the first electrode and a second terminal electrically coupled to the second electrode, and configured to accommodate the electrode group and an electrolyte;
preparing a long first lead used for electrically coupling the first terminal to an external apparatus;
overlaying a planned welding portion of the first lead on the first terminal of the container, and then, in order to preheat the planned welding portion, forming a first laser irradiation mark by radiating a laser to a position near the planned welding portion in a longitudinal direction of the first lead: and
welding the first lead to the first terminal and forming a first welding mark, by radiating a laser to the planned welding portion in a state in which the planned welding portion is preheated,
wherein each of the first laser irradiation mark and the first welding mark includes:
a projecting curved first portion projecting on a first side on which the first lead is electrically coupled to the external apparatus; or
a first portion including:
a linear portion extending in a width direction of the first lead; and curved portions curved from both ends of the linear portion toward a second side opposite to the first side.

12. The battery according to claim 2, wherein
in the width direction of the first lead, at least one of a welding start end and a welding final end of the first welding mark is located inside an outermost part of the first welding mark in the width direction of the first lead.
